(19) United States
(12) Patent Application Publication
(10) Pub. No.: US 2005/0166072 A1
(43) Pub. Date: Jul. 28, 2005

(54) Method and system for wireless morphing honeypot

(76) Inventors: Vikki Kim Converse, Lebanon, TN (US); Ronald O'Neal Edmark, Lebanon, TN (US); John Michael Garrison, Austin, TX (US)

Correspondence Address: IBM CORP (JRB);C/O LAW OFFICE OF JOSEPH R BURWELL, P O BOX 28022, AUSTIN, TX, 78755-8022, US

(21) Appl. No.: 11/086,715

(22) Filed: Mar. 22, 2005

Related U.S. Application Data
(63) Continuation-in-part of application No. 10/334,446, filed on Dec. 31, 2002.

(51) Int. Cl. H04L 9/00

(52) U.S. Cl. 713/201

(57) ABSTRACT

Characteristics of a wireless honeypot system are changed on a dynamic and configurable basis. A wireless access point device is configured to use a wireless protocol in accordance with user-specified values for configurable parameters in the wireless protocol. A configurable rule alters one or more values for one or more configurable parameters in the wireless protocol in response to a detected operational condition of the wireless access point device. A value for a configurable parameter in the wireless protocol is automatically altered in accordance with a configurable rule and a detected operational condition of the wireless access point device. An operation condition may include the usage, by a client, of an SSID or cryptographic key that is stored in a historical database of SSID's or cryptographic keys or an SSID or a cryptographic key that is currently being used by the wireless access point device for faux wireless communications.

### CROSS-REFERENCE TO RELATED APPLICATIONS

The present application is a continuation-in-part (CIP) application of the following applications with a common assignee:

U.S. patent application Ser. No. 10/334,446, filed Dec. 31, 2002, titled “Method and System for Morphing Honeypot”; and U.S. patent application Ser. No. 10/334,421, filed Dec. 31, 2002, titled “Method and System for Morphing Honeypot with Computer Security Incident Correlation”.

### BACKGROUND OF THE INVENTION

1. Field of the Invention

The present invention relates to an improved data processing system and, in particular, to a method and apparatus for computer security.

2. Description of Related Art

The connectivity of the Internet provides malicious users with the ability to probe data processing systems and to launch attacks against computer networks around the world. While computer security tools provide defensive mechanisms for limiting the ability of malicious users to cause harm to a computer system, computer administrators are legally limited in their ability to employ offensive mechanisms. Although an intrusion detection system can alert an administrator to suspicious activity so that the administrator can take actions to track the suspicious activity and to modify systems and networks to prevent security breaches, these systems can typically only gather information about possible security incidents.

Honeypots have been developed as a tool to help computer security analysts and administrators in coping to a small degree with malicious computer activity. A honeypot has been defined as a resource that has value in being probed, attacked, or compromised. A resource may be an application, an object, a document, a page, a file, other data, executable code, other computational resource, or some other type of communication-type resource. For example, a honeypot may comprise a network of servers; a honeypot server is sometimes called a decoy server.

A typical honeypot is a computer server that has limited or no production value; in other words, a typical honeypot performs no significant work within an enterprise other than monitoring for activity. Since the honeypot has no significant production value, its significant value lies in the fact that it acts as a decoy to lure malicious users or hackers to probing or attacking it. In the meantime, it is hoped that a malicious user would ignore production systems that have true value within an enterprise. In addition, the honeypot collects information about probes or attacks. From this perspective, a honeypot provides a tool with a small offensive capability. Ideally, the honeypot maintains a malicious user's interest so that significant information can be gathered about the methods of operation of the malicious user and whether any computer security flaws are discovered that require immediate administrative attention.

Preventive measures are usually taken so that a malicious user does not discover the true nature of the honeypot; otherwise, the malicious user would ignore the honeypot and begin probing other systems. For example, steps are usually taken to hide any administrative information within a computer network about the existence of a honeypot so that a malicious user does not capture and read about the configuration of a honeypot, e.g., activity logs or special file names. Hence, it is common practice to configure honeypots as relatively simple systems with little activity so that sophisticated, malicious users do not detect any activity that might lead this type of user to suspect that a system that is being probed is a honeypot. For this reason, honeypots are typically taken offline to be administratively analyzed and manually reconfigured. While providing some utility, a typical honeypot remains a passive tool with limited utility.

Most computer security incidents are initiated by malicious users through the Internet, which provides a psychological and physical buffer between a malicious user and the computer resource that is being probed or attacked. Although a typical malicious user gains some advantage by being physically remote from a computer resource that is maliciously targeted, a malicious user yields some advantages to computer security analysts and administrators. While probing or attacking a targeted computer resource, the physical network connections and/or higher-level communication sessions through the intermediate networks between the malicious user and the targeted computer resource may be logged in some manner, thereby generating electronic evidence of the malicious user's actions. The electronic evidence from intermediate networks and communication sessions is somewhat reduced, however, when a malicious user targets a computer resource more directly through a wireless network; this is potentially both advantageous and disadvantageous because the amount and scope of electronic evidence is reduced.

Although computer security incidents may be initiated more often through physical networks, the increasingly widespread deployment of wireless networks has been accompanied by probes and attacks on computer resources through those wireless networks, and computer security analysts and administrators confront wireless-specific advantages and disadvantages when dealing with wireless-network-based probes and attacks. Even though a wireless network provides some advantages because users are untethered from physical connections, the deployment of a wireless network introduces security vulnerabilities. This situation frequently exists because manufacturers typically ship wireless network devices that have been configured so that most users can quickly and easily set up a wireless network; however, these initial configurations are generally insecure. Unfortunately, wireless networks often remain deployed in an insecure configuration. Many steps can be performed to enhance the security of a wireless network, but depending upon the amount of effort employed by a malicious user, a determined malicious user may still gain access to a wireless network via its wireless access points. Hence, computer resources become more vulnerable because of the inadvertently enhanced ability of malicious users to probe or attack computer resources that are accessible through those wireless networks.

Therefore, it would be advantageous to employ a honeypot in a more offensive role for assisting a system administrator in detecting malicious activity. It would be particularly advantageous to implement a wireless honeypot for detecting malicious activity that is initiated via a wireless network.

### SUMMARY OF THE INVENTION

A method, system, apparatus, or computer program product is presented for morphing or changing characteristics of a wireless honeypot system on a dynamic and configurable basis. A wireless access point device is configured to use a wireless protocol in accordance with user-specified values for configurable parameters in the wireless protocol. A configurable rule is obtained for altering one or more values for one or more configurable parameters in the wireless protocol in response to a detected operational condition of the wireless access point device. A value for a configurable parameter in the wireless protocol is automatically altered in accordance with a configurable rule and a detected operational condition of the wireless access point device. An operation condition may include the usage, by a client, of an SSID that is stored in a historical database of SSID's or an SSID that is currently being used by the wireless access point device for faux wireless communications. An operation condition may include the usage, by a client, of a cryptographic key that is stored in a historical database of cryptographic keys or a cryptographic key that is currently being used by the wireless access point device for faux wireless communications.

### BRIEF DESCRIPTION OF THE DRAWINGS

The novel features believed characteristic of the invention are set forth in the appended claims. The invention itself, further objectives, and advantages thereof, will be best understood by reference to the following detailed description when read in conjunction with the accompanying drawings, wherein:

FIG. 1A depicts a typical distributed data processing system in which the present invention may be implemented;

FIG. 1B depicts a typical computer architecture that may be used within a data processing system in which the present invention may be implemented;

FIG. 2 depicts a set of dimensions for a database of known vulnerabilities;

FIG. 3 depicts a diagram of a set of modes of operation for a typical honeypot;

FIG. 4 depicts a diagram of a set of modes of operation for the morphing honeypot of the present invention;

FIG. 5A depicts a block diagram of a set of components or modules that may be used within a system that supports a morphing honeypot in accordance with an embodiment of the present invention;

FIG. 5B depicts a block diagram of a set of components or modules that may be used within a system that supports a wireless morphing honeypot in accordance with an embodiment of the present invention;

FIG. 6 depicts a flowchart for an overall process for operating a morphing honeypot to report suspicious probing events and for automatically altering the vulnerabilities that are exhibited by a morphing honeypot;

FIG. 7A depicts a flowchart for dynamically determining when to alter information that indicates that a morphing honeypot has vulnerable characteristics in accordance with monitored conditions;

FIG. 7B depicts a more specific flowchart for dynamically determining when to alter information that indicates that a wireless morphing honeypot has vulnerable characteristics in accordance with monitored conditions;

FIG. 8A depicts a flowchart that shows some of the monitoring conditions that might be evaluated during the operation of a morphing honeypot;

FIG. 8B depicts a more specific flowchart that shows some of the monitoring conditions that might be considered by a wireless morphing honeypot;

FIG. 9 depicts a flowchart that shows a process for dynamically determining when to alter the information that indicates that the honeypot has vulnerable characteristics in accordance with event notifications; and

FIG. 10 depicts a block diagram that illustrates the manner in which a wireless morphing honeypot may be employed to physically locate and track suspicious client devices that may be attempting to probe the computation assets of an enterprise using known vulnerabilities in wireless protocols.

### DETAILED DESCRIPTION OF THE INVENTION

In general, the devices that may comprise or relate to the present invention include a wide variety of data processing technology. Therefore, as background, a typical organization of hardware and software components within a distributed data processing system is described prior to describing the present invention in more detail.

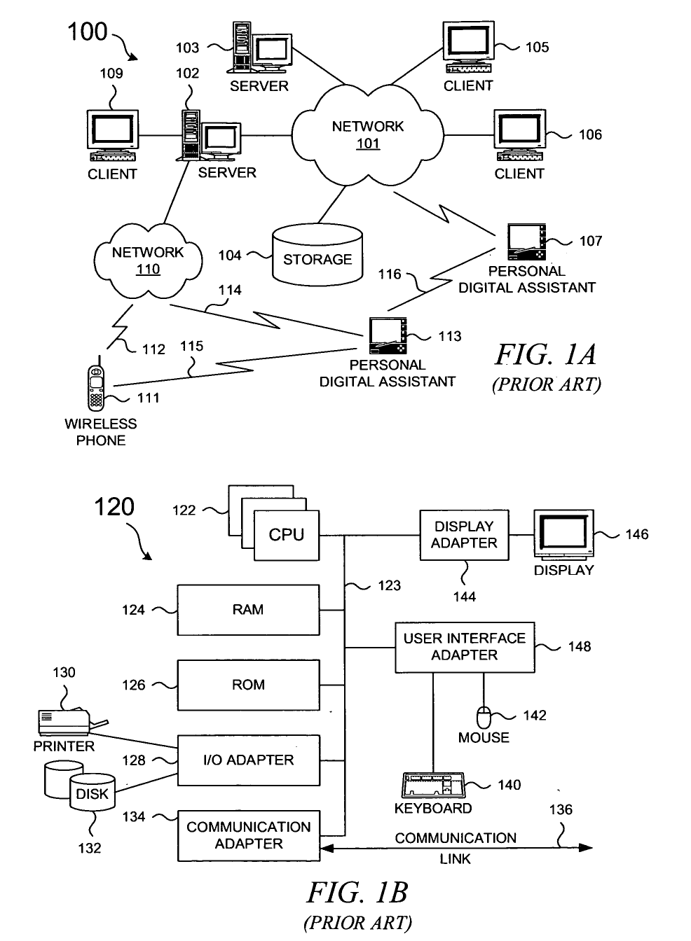

With reference now to the figures, FIG. 1A depicts a typical network of data processing systems, each of which may implement a portion of the present invention. Distributed data processing system 100 contains network 101, which is a medium that may be used to provide communications links between various devices and computers connected together within distributed data processing system 100. Network 101 may include permanent connections, such as wire or fiber optic cables, or temporary connections made through telephone or wireless communications. In the depicted example, server 102 and server 103 are connected to network 101 along with storage unit 104. In addition, clients 105-107 also are connected to network 101. Clients 105-107 and servers 102-103 may be represented by a variety of computing devices, such as mainframes, personal computers, personal digital assistants (PDAs), etc. Distributed data processing system 100 may include additional servers, clients, routers, other devices, and peer-to-peer architectures that are not shown.

In the depicted example, distributed data processing system 100 may include the Internet with network 101 representing a worldwide collection of networks and gateways that use various protocols to communicate with one another, such as Lightweight Directory Access Protocol (LDAP), Transport Control Protocol/Internet Protocol (TCP/IP), File Transfer Protocol (FTP), Hypertext Transport Protocol (HTTP), Wireless Application Protocol (WAP), etc. Of course, distributed data processing system 100 may also include a number of different types of networks, such as, for example, an intranet, a local area network (LAN), or a wide area network (WAN). For example, server 102 directly supports client 109 and network 110, which incorporates wireless communication links. Network-enabled phone 111 connects to network 110 through wireless link 112, and PDA 113 connects to network 110 through wireless link 114. Phone 111 and PDA 113 can also directly transfer data between themselves across wireless link 115 using an appropriate technology, such as Bluetooth™ wireless technology, to create so-called personal area networks (PAN) or personal ad-hoc networks. In a similar manner, PDA 113 can transfer data to PDA 107 via wireless communication link 116.

The present invention could be implemented on a variety of hardware platforms; FIG. 1A is intended as an example of a heterogeneous computing environment and not as an architectural limitation for the present invention.

With reference now to FIG. 1B, a diagram depicts a typical computer architecture of a data processing system, such as those shown in FIG. 1A, in which the present invention may be implemented. Data processing system 120 contains one or more central processing units (CPUs) 122 connected to internal system bus 123, which interconnects random access memory (RAM) 124, read-only memory 126, and input/output adapter 128, which supports various I/O devices, such as printer 130, disk units 132, or other devices not shown, such as an audio output system, etc. System bus 123 also connects communication adapter 134 that provides access to communication link 136. User interface adapter 148 connects various user devices, such as keyboard 140 and mouse 142, or other devices not shown, such as a touch screen, stylus, microphone, etc. Display adapter 144 connects system bus 123 to display device 146.

Those of ordinary skill in the art will appreciate that the hardware in FIG. 1B may vary depending on the system implementation. For example, the system may have one or more processors, such as an Intel® Pentium®-based processor and a digital signal processor (DSP), and one or more types of volatile and non-volatile memory. Other peripheral devices may be used in addition to or in place of the hardware depicted in FIG. 1B. The depicted examples are not meant to imply architectural limitations with respect to the present invention.

In addition to being able to be implemented on a variety of hardware platforms, the present invention may be implemented in a variety of software environments. A typical operating system may be used to control program execution within each data processing system. For example, one device may run a Unix® operating system, while another device contains a simple Java® runtime environment. A representative computer platform may include a browser, which is a well known software application for accessing hypertext documents in a variety of formats, such as graphic files, word processing files, Extensible Markup Language (XML), Hypertext Markup Language (HTML), Handheld Device Markup Language (HDML), Wireless Markup Language (WML), and various other formats and types of files.

The present invention may be implemented on a variety of hardware and software platforms, as described above with respect to FIG. 1A and FIG. 1B. More specifically, though, the present invention is directed to operating a morphing honeypot, as described in more detail below with respect to the remaining figures.

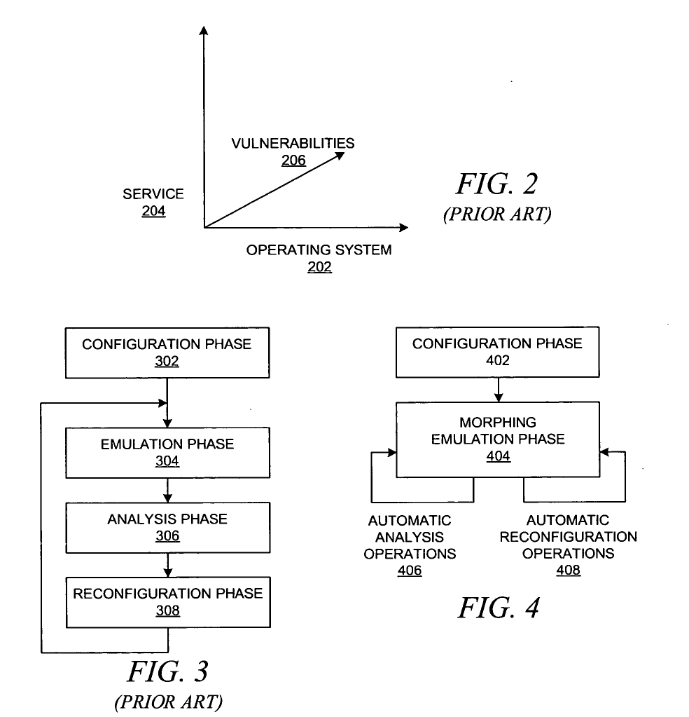

With reference now to FIG. 2, a diagram depicts a set of dimensions for a typical database of known vulnerabilities. As is well-known, a database of known vulnerabilities can be compiled through empirical observation. Information about multiple operating systems 202 can be stored in the vulnerability database along with a set of associated services 204 that execute with support from an operating system. A particular type of service, such as an FTP server, is implemented under different operating systems using different code libraries, and each implementation of a particular type of service has its own set of known vulnerabilities 206. A vulnerability in a service is typically discovered by accident, by trial and error via a legitimate testing procedure, or by trial and error via malicious attempts to break the service. Information about these vulnerabilities are stored, compiled, and shared amongst various groups of users or organizations; persons who attempt to secure systems against vulnerabilities are often termed “whitehats”, while persons who attempt to harm systems by exploiting vulnerabilities are often termed “blackhats”.

For example, a vulnerability might be discovered, either accidentally or maliciously, when an invalid value for a particular parameter (or a set of values for multiple parameters in which the combination of values is somehow invalid) is sent within a request message or a data packet to a particular service. When the service attempts to process the message or data packet containing the invalid value, the service may behave erratically or erroneously, possibly because it has not been programmed to handle the exception that is posed by the invalid value. The improper behavior of the service causes some form of problem within the operating system or the system in general, possibly forcing the operating system into some form of exception processing. In some cases, the vulnerability exploits a buffer overflow technique in which a service accepts a large amount of data that overflows the memory buffer into which the service is capturing the incoming data. The incoming data, however, is actually executable code for the receiving system, and the system is manipulated into executing the received executable code. In some cases, the system can be manipulated into recognizing the received executable code as the service's own executable code. Given the fact that the service often executes at a higher level of priority or with special privileges under the operating system because it is a system-level service, the received executable code can thereafter perform a wide range of operations with system-level privileges, which can have devastating consequences. From that point forward, a malicious user may copy confidential information, destroy data, reconfigure systems, hide so-called back-door programs, and perform a variety of other nefarious activities.

A particular vulnerability exists within a particular operating system and service. More specifically, since operating systems and services are continually improved through patches to fix vulnerabilities or updated to comprise new features, a particular vulnerability exists within a particular version of an operating system and/or a particular version of a service. Hence, a particular technique for exploiting a vulnerability is successful against a limited number of configurations of operating systems and services, possibly only a unique combination of a particular version of a service on a particular version of an operating system.

Given that a particular technique for exploiting a known vulnerability is successful only against certain system configurations, a malicious user usually attempts to probe a particular service. A service is typically probed by sending the service a set of messages or malformed data packets and then observing and analyzing the responses in an attempt to identify the particular version of an operating system, the particular version of a service at the probed system, or other information. In some cases, this information is explicitly provided in the response. In other cases, this information is gleaned from the values of parameters that are returned from the system by matching these values with values that are known to be returned by particular services or versions of services. In any case, the information that is returned in the responses from a particular system provides information about the configuration of that system, and given the fact that a particular configuration of an operating system and/or an associated service may have a vulnerability, the information that is returned in the responses from a particular system also provides information about the vulnerable characteristics of that system. A group of vulnerable characteristics of a system can be termed the system's “personality”; in other words, the manner in which the system exhibits certain behaviors in response to certain requests comprises the system's personality.

The process of matching content from the service responses with known values is termed “fingerprinting”. These known values have also been compiled into databases, and various utilities exist for fingerprinting a system. These fingerprinting utilities can be used for legitimate purposes in order to identify the fact that a system is providing information about its vulnerable characteristics, or these fingerprinting utilities can be used for nefarious activities in order to gather information about systems that a malicious user desires to attack. Given that a malicious user usually desires to escape detection and prosecution for illegal activities, a malicious user typically probes a system prior to attacking it so that the malicious user can determine if the system has a vulnerability that can be exploited. Otherwise, the malicious user risks detection and prosecution for launching an attack that cannot succeed. After receiving information about particular vulnerable characteristics of a system, the malicious user can choose particular techniques for exploiting the vulnerable characteristics of the system through an attack on the system.

Rather than actively fingerprinting a system by sending it particular requests, a system can also be passively fingerprinted by observing or tracing responses to legitimate requests. In addition, fingerprinting can also work in the opposite manner through a process of reverse fingerprinting in which requests from a system are traced. By analyzing the values of parameters within the incoming request messages or data packets, it may be possible to identify configuration information about the requesting system. Moreover, since the manner in which a given, publicly available, fingerprinting utility operates is well-known, it is also possible to identify a fingerprinting utility through the manner in which it generates malformed requests or data packets during its fingerprinting operations.

With reference now to FIG. 3, a diagram depicts a set of modes of operation for a typical honeypot. A typical lifecycle for a honeypot can be categorized as a series of operational phases or a series of modes of operation. An administrative user configures a honeypot during a configuration phase (step 302), which may comprise a variety of steps that depend upon the particular honeypot that will be operated. After initialization, the honeypot begins operating within an emulation phase (step 304) during which one or more services are emulated while information about requests to those services are collected and logged. After a period of time, the honeypot is brought offline, and the logged information is then examined during an analysis phase (step 306). The analysis may include a determination that the system was probed during the emulation phase. In any case, an administrative user determines whether the configuration of the honeypot should be changed during a reconfiguration phase (step 308), e.g., in response to previous probes. After performing any required or desired reconfigurations, the honeypot is again brought online, and the cycle repeats as long as deemed necessary by the administrator.

With reference now to FIG. 4, a diagram depicts a set of modes of operation for the morphing honeypot of the present invention. In a manner similar to the process that is shown in FIG. 3, the morphing honeypot undergoes a configuration phase (step 402). In contrast to the process that is shown in FIG. 3, however, an morphing emulation phase with the present invention (step 404) continues while analysis operations (step 406) are automatically conducted along with automatic reconfiguration operations (step 408), as explained in more detail below.

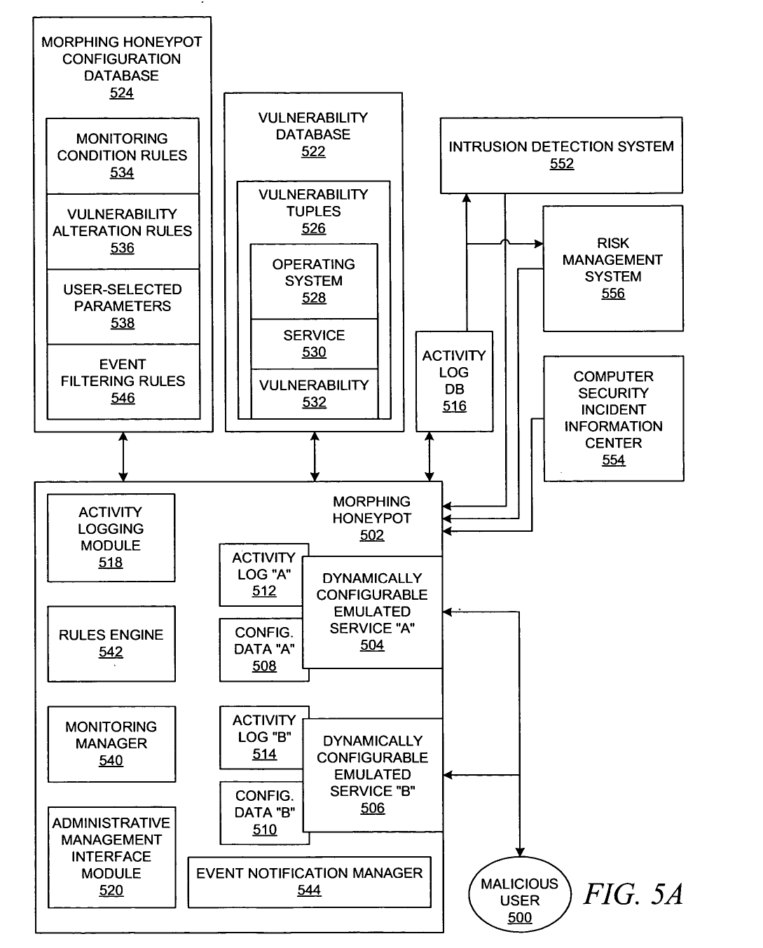

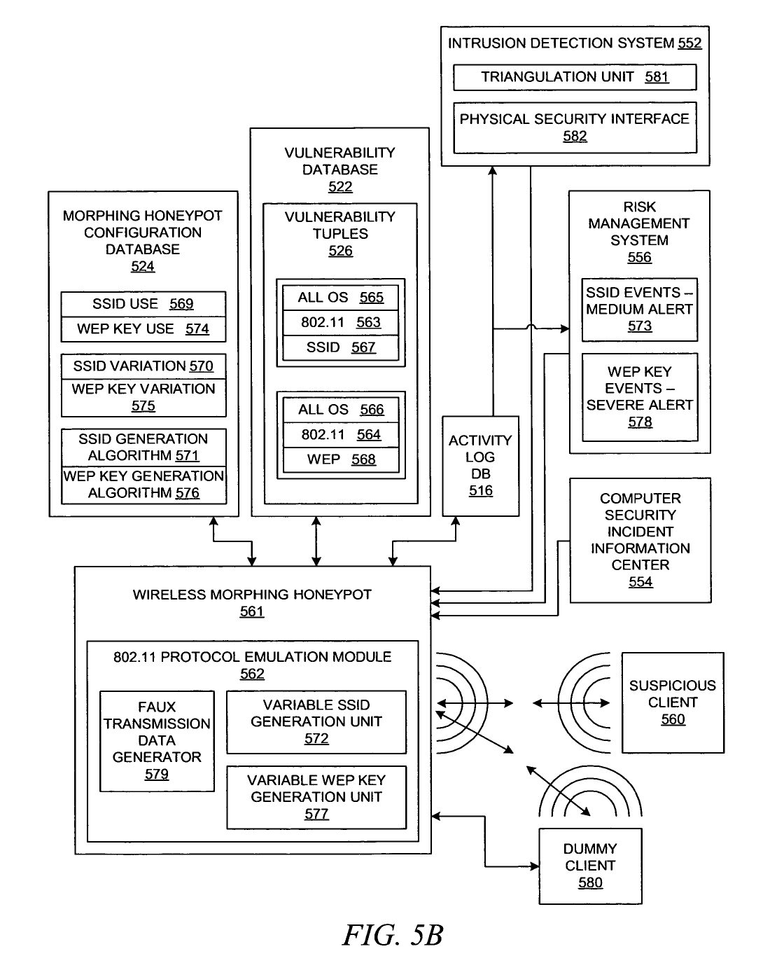

With reference now to FIG. 5A, a block diagram depicts a set of components or modules that may be used within a system that supports a morphing honeypot in accordance with an embodiment of the present invention. Malicious user 500 acts to probe, to attack, or to compromise morphing honeypot 502, which emulates two different services in this example: dynamically configurable emulated service 504 and dynamically configurable emulated service 506. The set of services that are emulated by the morphing honeypot represent a type of facade on the underlying system. The facade may include virtual directories and files that are available for retrieval and/or manipulation by a malicious user. For each request that is received by an emulated service, the emulated service generates a response containing information about morphing honeypot 502. In a manner that would be expected for a production system, the emulated services of the morphing honeypot present information about vulnerable characteristics of the morphing honeypot as if it were a production system that is supporting a particular version of an operating system along with particular versions of the services that are executing on that operating system. In other words, the information that is returned by the emulated services in response to requests that are received by those emulated services allows malicious user 500 to fingerprint the emulated service. In response to fingerprinting an emulated service at morphing honeypot 502, the malicious user would determine one or more vulnerabilities that are typically possessed by other systems with similar fingerprints, after which malicious user 500 may launch attacks that are directed at those vulnerabilities.

Morphing honeypot 502 may or may not truly possess any of the indicated vulnerabilities, depending upon the operating system and associated set of services that are executing on morphing honeypot 502. However, the returned information should be interpreted by a malicious user as indicating a set of vulnerable characteristics at the morphing honeypot.

Each emulated service is configured through a set of parameters, such as configuration dataset 508 for emulated service 504 and configuration dataset 510 for emulated service 506; each set instructs the behavior of the associated emulated service. As each emulated service responds to requests, the activities of the service are logged, either locally into a local dataset, such as activity log dataset 512 for emulated service 504 and activity log dataset 514 for emulated service 506, or system-wide into activity log database 516 through activity logging module 518. An activity log or dataset may have information about the content of any requests that were received by any service supported by morphing honeypot 502, including emulated services 504 and 506, the time and conditions of the receipt of those requests, and information about the actions that were taken by the emulated services or the morphing honeypot as a whole, including the response that was returned for a given request. Other activity may be logged, such as any operations that are performed on behalf of an administrative user through administrative management interface module 520, which may be simply an interface to a management utility that controls morphing honeypot 502 or may comprise the functionality for acting as a management utility to control morphing honeypot 502.

Administrative management interface module 520 allows an administrative user to manage the operations of morphing honeypot 502 and the information that is stored within any databases that used by morphing honeypot 502, such as activity log database 516, vulnerability database 522, and morphing honeypot configuration database 524. Vulnerability database 522 may be created by morphing honeypot 502, or vulnerability database 522 may be obtained through other means; for example, as described above, vulnerability databases may be generated through other utilities or tools, or a vulnerability database may be obtained from a user group or possibly a security information center that disseminates information about computer security advisories, such as the CERT® Coordination Center (CERT/CC) operated by Carnegie Mellon University. A vulnerability database may have various forms of information; vulnerability database 522 is organized to contain vulnerability tuples 526, each of which includes an indication of a version of an operating system 528, an indication of a version of computer service 530, and an indication of a known vulnerability 532 for the associated version of the operating system and the associated version of a computer service.

Morphing honeypot configuration database 524 contains monitoring condition rules 534, vulnerability alteration rules 536, and user-selected parameters 538, which are used in conjunction with the rules within the database or in some other manner by the morphing honeypot. Monitoring condition rules 534 and vulnerability alteration rules 536 may be manipulated, created, or deleted by an administrative user through administrative management interface module 520. Monitoring manager 540 uses rules engine 542 to evaluate the expressions within monitoring condition rules 534 to detect user-specified monitoring conditions within the emulated services. After a user-specified monitoring condition is detected, monitoring manager 540 uses rules engine 542 to evaluate the expressions within vulnerability alteration rules 536 to determine the next set of vulnerable characteristics that should be presented by the emulated services. Monitoring manager 540 obtains information from vulnerability database 522 for that set of vulnerable characteristics, i.e. the information that should be presented by an emulated service to indicate that morphing honeypot 502 possesses a particular vulnerability. The information is written into the appropriate configuration dataset for the appropriate emulated service; the emulated service then places the configurable information into the responses that it returns for the requests that it receives.

As noted above, a computer security vulnerability is discovered through a variety of means, and it may be assumed that information about a vulnerability is disseminated to malicious users as well as computer security administrators. However, malicious users often try to exploit a newly discovered vulnerability soon after learning about the newly discovered vulnerability.

The morphing honeypot of the present invention provides a computer system administrator with the ability to enhance the attractiveness of the honeypot to a malicious user by presenting information about a newly discovered vulnerability as a characteristic of the morphing honeypot; the intent is to attract a malicious user to the morphing honeypot with the expectation that a malicious user would hunt for a system that possesses the newly discovered vulnerability.

In addition, groups of malicious users disseminate information about the manner in which a computer vulnerability is exploited. Hence, many malicious users try to exploit a particular vulnerability on many different systems. Moreover, a particular malicious user may repeatedly try to exploit a particular vulnerability on many systems within a single network.

The morphing honeypot of the present invention provides a computer system administrator with the ability to enhance the attractiveness of the honeypot to a malicious user by presenting information about a newly discovered vulnerability as a characteristic of the morphing honeypot; the intent is to attract a malicious user to the morphing honeypot with the expectation that a malicious user would hunt for a system that possesses the newly discovered vulnerability soon after learning about the vulnerability.

As a possibly more utilized feature, the morphing honeypot of the present invention also provides a computer system administrator with the ability to enhance the attractiveness of the honeypot to a malicious user by presenting information about a particular vulnerability at the morphing honeypot after determining that the malicious user has attempted to exploit the same vulnerability at a different system. Again, the intent is to attract a malicious user to the morphing honeypot with the expectation that a malicious user would continue hunting for a system that possesses a particular vulnerability.

The morphing honeypot of the present invention provides the ability to enhance its attractiveness in these scenarios by integrating various means to obtain, retrieve, or receive event notification messages that are generated external to the morphing honeypot. An event notification message provides information about a newly discovered vulnerability or a newly detected probe or attack; the morphing honeypot configures itself to exhibit characteristics of a newly discovered vulnerability or a newly detected probe or attack in an attempt to lure a malicious user into activity at the morphing honeypot.

Morphing honeypot 502 includes event notification manager 544 that performs some operations that are similar to monitoring manager 540. Event notification manager 544 integrates morphing honeypot 502 with various configurable event detection systems that are able to send event notification messages to morphing honeypot 502. An event notification message informs event notification manager 544 of a particular type of event; the format and content of the event notification message may be dependent upon the type of event detection system. Actions by event notification manager 544 and the receipt of event notification messages may also be logged into activity database 516; the number and type of event notification messages over time may result in a change in the displayed personality of the morphing honeypot. Although some examples of various sources of event notification messages are shown in FIG. 5A, the morphing honeypot may be integrated with a wide variety of external systems that either direct the operation of the morphing honeypot or assist in the operation of the morphing honeypot.

Event notification manager 544 interprets an event notification message, which may be encrypted and digitally signed to protect its data integrity. Event notification manager 544 has an ability to parse messages and to filter messages. In one embodiment, morphing honeypot 502 may be tightly integrated with the source of an event notification message; in response to receipt of a particular event notification message, morphing honeypot 502 may alter its personality in response to the receipt of information within an event notification message. In other words, the source system that generates the event notification message sends information that monitoring manager 540 uses directly to control an emulated service. In this scenario, the source system has already determined a condition that requires a change in the personality of the morphing honeypot and has also possibly determined a new vulnerability that the morphing honeypot should present within an emulated service. Event notification manager 544 uses information within the event notification message as information that should be placed within the configuration dataset of an emulated service.

In an alternative embodiment, event notification manager 544 uses information within an event notification message in a manner that is similar to the use of a satisfied monitoring condition within monitoring manager 540, i.e. as if the source system has already determined a condition that requires a change in the personality of the morphing honeypot. In this scenario, however, event notification manager 544 uses vulnerability alteration rules 536 to determine a new vulnerability that the morphing honeypot should present within an emulated service.

In another embodiment, event notification manager 544 uses information within an event notification message as input to monitoring manager 540, which then uses the event as merely one parameter while evaluating an expression within a monitoring condition rule. In this case, notification of an event is merely part of a condition that requires a change in the personality of the morphing honeypot. In this scenario, monitoring manager 540 uses vulnerability alteration rules 536 to determine a new vulnerability that the morphing honeypot should present within an emulated service when a monitoring condition rule is satisfied.

In yet another embodiment, event notification manager 544 uses information within an event notification message as parameters for evaluating expressions within event filtering rules 546, which are similar to monitoring condition rules but may be applicable primarily to detected events. Since detected events may be numerous, it may not be desirable to change the personality of a morphing honeypot for each detected event, and it may be desirable to change the personality of the morphing honeypot only upon detection of a particular combination of events. Event filtering rules 546 provide expressions for determining when to change the personality of a morphing honeypot in response to event notification messages.

Intrusion detection system 552 detects possible intrusions within a network, a system, or an application, possibly through analysis of logged information within activity log 516. For example, intrusion detection system 552 may represent an anti-virus application that monitors a system for infiltration by viruses. As another example, intrusion detection system 552 may be an instance of the Cisco® Secure Intrusion Detection System, which includes network sniffers for detecting unauthorized activity from data derived directly from a network; the Cisco® Secure Intrusion Detection System is configurable to send different types of alarm/event messages to different destinations.

Computer security incident information center 554 provides advisories and incident notes about widespread computer security problems, such as the CERT® Coordination Center (CERT/CC) that was mentioned above. Various computer security incident information centers exist for particular industries or organizations. For example, the Financial Services Information Sharing and Analysis Center (FS-ISAC) provides an industry-wide database of electronic security threats, vulnerabilities, incidents, and solutions for financial institutions. The Federal Computer Incident Response Center (FedCIRC) is the central coordination and analysis facility dealing with computer-security-related issues affecting the civilian agencies and departments of the federal government.

Event notification messages concerning identified threats and vulnerabilities may be retrieved from a database that is maintained by a computer security incident information center, e.g., the CERT Knowledgebase. Alternatively, event notification messages may be broadcast from a computer security incident information center to interested parties; morphing honeypot 502 may be required to register with the computer security incident information center in order to receive the event notification messages, e.g., the CERT advisory mailing list. In parallel with activities to change the personality of the morphing honeypot through its emulated services, event notification manager 544 may update morphing honeypot configuration database 524 or vulnerability database 522 in response to information from computer security incident information center 554.

Risk management system 556 represents another potential source of event notification messages. Risk management system 556 has the ability to correlate, evaluate, and escalate alarms/events from many different types of computer security sensors, e.g., network intrusion detection systems, anti-virus sensors, firewalls, or other sensors, possibly through analysis of logged information within activity log 516. An example of a risk management system is the IBM Tivoli Risk Manager, which correlates and prioritizes a vast number of security events that are generated across applications, operating systems, and network devices to provide an overall view of an enterprise's security architecture.

The exemplary embodiment of the present invention that is shown in FIG. 5A illustrates a general organization of components for implementing a morphing honeypot. In a more specific example, the techniques of the present invention may be applied in the wireless environment, e.g., as shown in FIG. 5B. It should be noted that although the examples of the present invention that are described hereinbelow primarily rely upon the IEEE 802® standards that have been created by the Institute of Electrical and Electronic Engineers, Inc. (IEEE), particularly the 802.11® family of specifications for wireless LANs, the present invention may be implemented using a variety of wireless communication protocols and technologies wherein vulnerabilities of those wireless communication protocols and technologies may be exploited within a wireless morphing honeypot. In addition, the wireless morphing honeypot system may simultaneously employ multiple wireless technologies; one or more wireless morphing honeypots may be implemented to support the hardware requirements of different wireless technologies. It should be noted, though, that the enterprise that deploys a wireless morphing honeypot is not necessarily required to employ the same wireless technology both for its active wireless network and for the wireless morphing honeypot system; the wireless morphing honeypot system may employ a different wireless technology in an overlapping manner.

With reference now to FIG. 5B, a block diagram depicts a set of components or modules that may be used within a system that supports a wireless morphing honeypot in accordance with an embodiment of the present invention. FIG. 5B is similar to FIG. 5A, and similar reference numerals refer to similar elements; other elements that are shown in FIG. 5A that are not shown in FIG. 5B may be assumed to be implemented but not shown in FIG. 5B. However, FIG. 5B differs from FIG. 5A; whereas FIG. 5A illustrates an example of a generalized morphing honeypot, FIG. 5B illustrates a more specific example of a morphing honeypot by including wireless functionality to produce a wireless morphing honeypot in accordance with a different embodiment of the present invention. Suspicious client 560, possibly operated by a malicious user, acts to probe, to attack, or to compromise wireless morphing honeypot 561 through wireless data transfers.

Wireless morphing honeypot 561 is not limited to monitoring the vulnerabilities that are discussed hereinbelow. The SSID and WEP vulnerabilities that are discussed hereinbelow are specific to the 802.11® protocols, and a wireless morphing honeypot may be configured to extend its capabilities in order to exploit other vulnerabilities that exist within other wireless technologies.

In addition, a wireless morphing honeypot may be configured to exploit other vulnerabilities that commonly exist in many wireless technologies. For example, many wireless technologies support network protocols that contain a MAC (Media Access Control) address. Most Layer-2 network protocols use one of three numbering spaces managed by the IEEE: MAC-48™, EUI-48™, and EUI-64™, which are designed to be globally unique so that they may act as unique identifiers for network cards and other network-related devices, although not all communications protocols use MAC addresses and not all protocols require such globally unique identifiers. Given the presence of a MAC address in a supported protocol, many network access devices perform a rudimentary security check on MAC addresses within transmitted data packets by applying a MAC address filter. By maintaining a list or database of the known MAC addresses of devices that have been approved for use on a network, a network access device can filter the data packets to check that each data packet contains a recognized MAC address.

However, a reliance on a MAC address filter presents a simple vulnerability. A malicious user can bypass a MAC address filter by spoofing a MAC address of a known approved device within the data packets that are transmitted by the malicious user's client device. A malicious user can easily obtain a MAC address of a known approved device by sniffing the wireless data transmissions of a known approved device; the obtained MAC address is then used by the malicious user's configurable wireless device rather than the MAC address that was originally assigned to the wireless device. Since the data packets in the wireless transmissions of the malicious user's device would then contain a recognized MAC address, the MAC address filtering functionality will not flag or reject the received data packets from the malicious user. In any case, most implementations of the present invention may exploit a MAC address vulnerability in addition to other vulnerabilities as discussed in more detail further below and as illustrated within FIG. 5B.

Wireless morphing honeypot 561 emulates an 802.11® wireless protocol using 802.11® protocol emulation module 562. For each request that is received by 802.11® protocol emulation module 562, the emulated service generates a response; given an exchange of data, a malicious user is deceived into an assumption that the malicious user is operating suspicious client 560 to communicate with an enterprise's active wireless network. In other words, wireless morphing honeypot 561 acts as a wireless access point device or emulator, and in response to discovering the wireless access point of wireless morphing honeypot 561, a malicious user of suspicious client 560 could attempt to access a network through wireless morphing honeypot 561 in order to attempt to access files or possibly to launch attacks that are directed at other vulnerabilities within the network.

Vulnerability database 522 may be implemented in a variety of ways; in the example that is shown in FIG. 5B, vulnerability database 522 is organized to contain vulnerability tuples 526, each of which includes an indication of the operating systems in which the vulnerability is applicable, an indication of a version of data service that has vulnerabilities that may be exploited, and an indication of a known vulnerability for the associated version of the operating system and the associated version of a data service. Depending on the wireless technology, different software packages on different operating systems may implement its support for a wireless technology in a manner that introduces a vulnerability, thereby providing the wireless morphing honeypot system with an extra degree of variability in presenting different vulnerabilities for different operating systems.

In the example that is shown in FIG. 5B, vulnerability database 522 contains known vulnerabilities for the 802.11® protocol, as indicated by data values 563 and 564; in this example, these vulnerabilities are assumed to be present within any operating system that implements a wireless access point using the 802.11® protocol, as indicated by data values 565 and 566. SSID indicating value 567 identifies the use of an SSID (Service Set ID) as a possible vulnerability of an 802.11® wireless access point that may be exploited by a wireless morphing honeypot; the SSID within the 802.11® wireless protocol represents a configurable parameter for the 802.11® wireless protocol. WEP indicating value 568 identifies the use of the WEP (Wired-Equivalent Privacy) encryption mechanism as a possible vulnerability of an 802.11® wireless access point that may be exploited by a wireless morphing honeypot; the WEP encryption key within the 802.11® wireless protocol represents a configurable parameter for the 802.11® wireless protocol.

An SSID is an alphanumeric code that is entered as a configuration parameter into all wireless access points and wireless clients that participate on the same wireless network. An SSID acts as a type of simple workgroup identifier; any entity that knows the SSID may be rudimentarily regarded as belonging to the group of entities that might be provided wireless access to a network. In a default configuration, a wireless access point would periodically broadcast the SSID, thereby allowing software on a wireless client to compile a list of available wireless networks within the vicinity of the wireless client. In addition, each vendor of a commercially available wireless access point provides a default value for the SSID. In order to provide a rudimentary level of security for the network behind a wireless access point, a network administrator typically changes the default value of the SSID to some other value and disables the broadcasting of the SSID; legitimate users and legitimate client devices are then configured with the appropriate SSID. Assuming that the wireless access point does not broadcast the SSID, the unique SSID should not be known to a suspicious client, thereby making it more difficult for the suspicious client to discover the SSID.

Vulnerability database 522 contains indicator 567 that identifies the SSID mechanism as a vulnerability that can be exploited by wireless morphing honeypot 561 to attract a malicious user. Morphing honeypot configuration database 524 contains monitoring condition rule 569 that provides interpretable expressions for enabling or disabling the use of the SSID vulnerability within wireless morphing honeypot 561. Morphing honeypot configuration database 524 also contains vulnerability alteration rule 570 for determining when and/or how to vary an SSID. Morphing honeypot configuration database 524 further contains SSID generation algorithm 571, which is a user-selectable parameter that provides an algorithm that is used to determine or to vary the values of the SSID's that are used. Wireless morphing honeypot 561 contains variable SSID generation unit 572 that uses SSID generation algorithm 571 to generate SSID's in accordance with SSID generation algorithm 571 when the SSID vulnerability is enabled. When wireless morphing honeypot 561 detects that suspicious client 560 is actively exploiting the SSID vulnerability, as explained in an example further below, wireless morphing honeypot 561 notifies risk management system 556, which has configuration parameter 573 that indicates that risk management system 556 should issue a medium-level alert in response to the detected event.

The 802.11® protocol provides an optional WEP encryption mechanism in which a digital, symmetric, cryptographic key is used to encrypt transmitted data in order to prevent a suspicious client from discovering important data by sniffing wireless transmissions to and from a wireless access point. The WEP mechanism can be problematic due to key management. Without some type of centralized mechanism for managing and distributing keys to wireless access points and clients, a system administrator faces significant work in changing a WEP key because the system administrator must change the keys on all wireless access points and all clients in order to secure the networked environment properly. The WEP key should not be known to unknown wireless clients or malicious users. With the wireless honeypot of the present invention, the WEP mechanism can be exploited as a vulnerability to attract and capture activity of malicious users.

Vulnerability database 522 contains indicator 568 that identifies the WEP mechanism as a vulnerability that can be exploited by wireless morphing honeypot 561 to attract a malicious user. Morphing honeypot configuration database 524 contains monitoring condition rule 574 that provides interpretable expressions for enabling or disabling the use of the WEP mechanism within wireless morphing honeypot 561. Morphing honeypot configuration database 524 also contains vulnerability alteration rule 575 for determining when and/or how to vary the WEP key. Morphing honeypot configuration database 524 further contains WEP key generation algorithm 576, which is a user-selectable parameter that provides an algorithm that is used to determine or to vary the values of the WEP keys that are used. Wireless morphing honeypot 561 contains variable WEP key generation unit 577 that uses WEP key generation algorithm 576 to generate WEP keys in accordance with WEP key generation algorithm 576 when the WEP key vulnerability is enabled. When wireless morphing honeypot 561 detects that suspicious client 560 is actively exploiting the WEP key vulnerability, as explained in an example further below, wireless morphing honeypot 561 notifies risk management system 556, which has configuration parameter 578 that indicates that risk management system 556 should issue a high-level severe alert in response to the detected event.

Wireless morphing honeypot 561 also contains faux transmission data generator 579 for generating data that wireless morphing honeypot 561 transmits in a fake broadcast; the faux transmission data allow suspicious client 560 to sniff data, as explained in an example further below. Dummy client 580 may be implemented to send data requests to wireless morphing honeypot 561, which responds with the faux transmission data, thereby providing a more realistic two-way data transfer that may be sniffed by suspicious client 560.

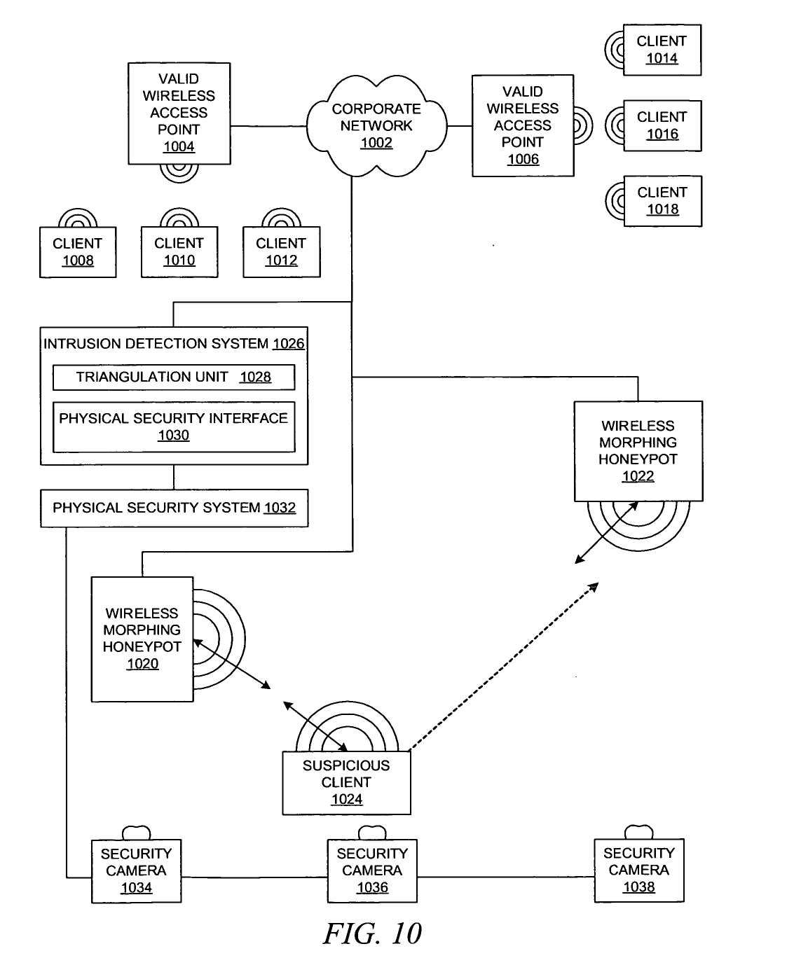

Intrusion detection system 552 contains triangulation unit 581 for attempting to physically locate and track suspicious client 560 in response to detected events. In addition, intrusion detection system 552 contains physical security system interface 582 for providing information that allows an operator to employ physical assets to locate and track suspicious client 560, as explained further below with respect to an example that is illustrated in FIG. 10.

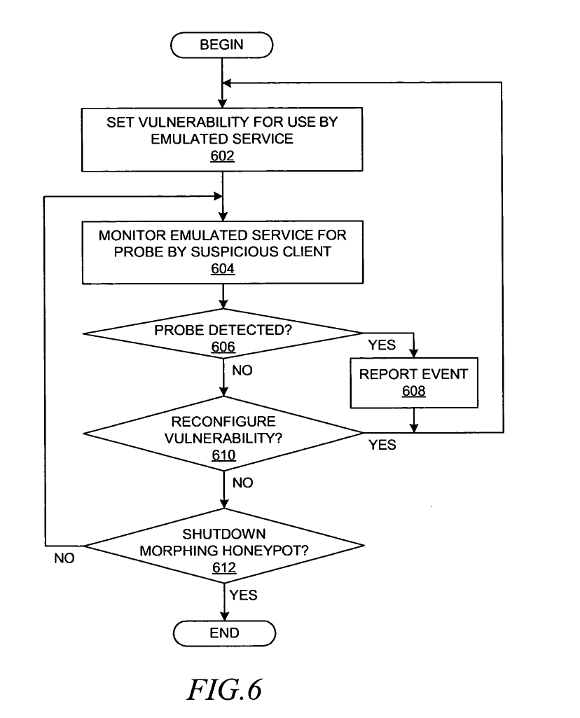

With reference now to FIG. 6, a flowchart depicts an overall process for operating a morphing honeypot to report suspicious probing events and for automatically altering the vulnerabilities that are exhibited by a morphing honeypot. The process commences by setting a vulnerability within the emulated service (step 602) such that the chosen vulnerability might be exploited by a malicious user. The morphing honeypot then monitors the emulated service for indications that a suspicious client that is operated by a malicious user is attempted to exploit the known vulnerability in the emulated service (step 604).

If a probe, i.e. a probing operation, is detected (step 606), then the morphing honeypot reports the event to an appropriate subsystem for further actions (step 608). After the suspicious client has been detected, the process may loop back to step 602; for example, a new vulnerability might be chosen for use by the emulated service in order to attract a probing operations by other malicious users, after which the morphing honeypot repeats the process.

If a probe, i.e. a probing operation, is not detected at step 606, then the morphing honeypot determines whether configurable parameters indicate that the morphing honeypot should reconfigure itself to present a different vulnerability (step 610). If so, then the process loops back to step 602 to choose a different vulnerability; if not, then the morphing honeypot determines whether it should shutdown (step 612), e.g., in accordance with configurable parameters or in response to a request from a system administrative user. If not, then the morphing honeypot loops back to step 604 to continue monitoring for suspicious activity; if so, then the morphing honeypot is halted, thereby concluding the process. In this manner, the morphing honeypot performs its monitoring operations and its reconfiguration operations in a continuous loop until instructed to do otherwise.

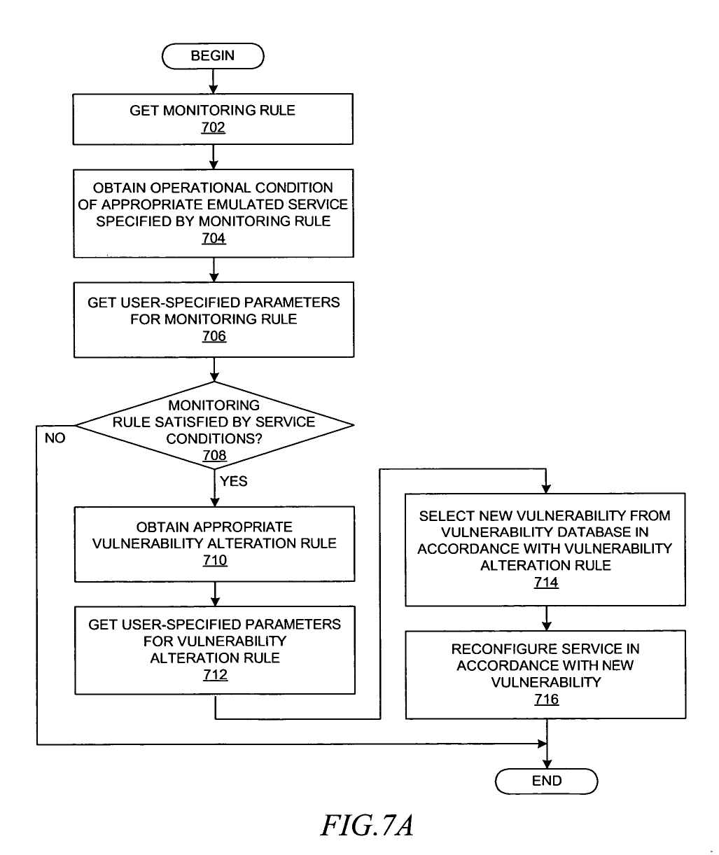

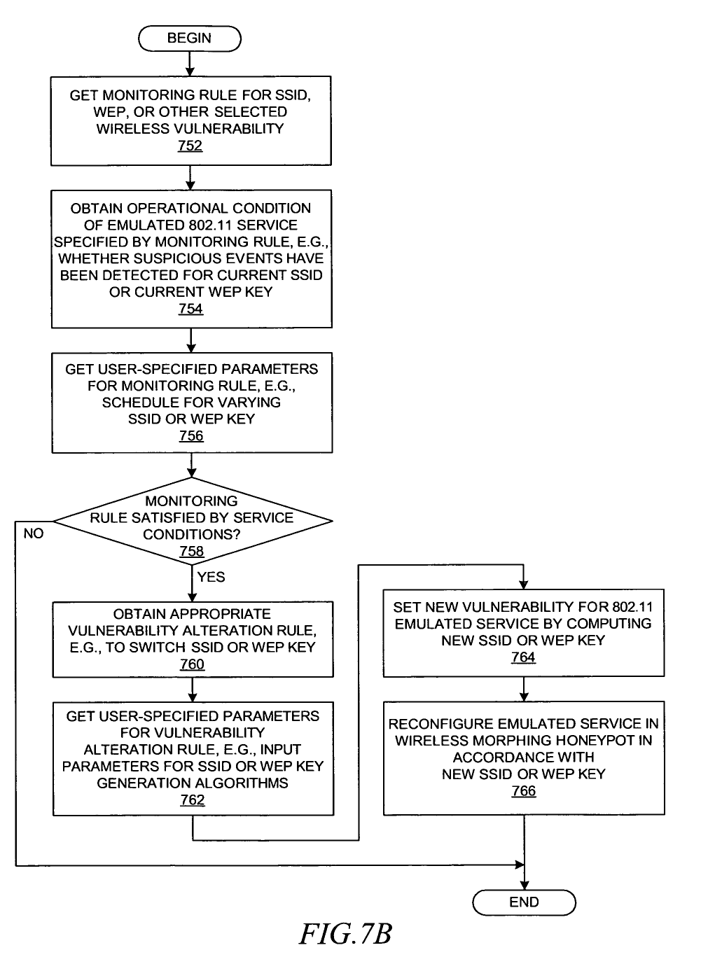

With reference now to FIG. 7A, a flowchart depicts a process for dynamically determining when to alter the information that indicates that a morphing honeypot has vulnerable characteristics in accordance with monitored conditions. The process begins by obtaining a monitoring rule, e.g., from a monitoring rule database or some other database associated with the morphing honeypot (step 702). The retrieved monitoring rule may be applicable to one or more emulated services, but assuming that the retrieved monitoring rule is applicable to one particular type of emulated service, then the operational condition of the appropriate emulated service, as indicated in the monitoring rule, is retrieved (step 704). The operational condition may include an activity log for the emulated service, but the operational condition may also include information that is maintained by the emulated service or by a monitoring manager that communicates with the emulated service. For example, the operational condition may include a timestamp for the most recent reconfiguration of the emulated service or for other operations that are internal to the morphing honeypot; in contrast, the activity log may indicate only actions that have occurred with respect to entities external to the morphing honeypot.

Any user-specified parameters that may be applicable to the retrieved monitoring rule are also retrieved (step 706). The monitoring rule may be configured as an expression with variables, and the user-specified parameters may be used as input into the expression prior to evaluating the expression. In this manner, a set of monitoring rules may be stored like a template, and the user-specified parameters configure the monitoring rules for a particular honeypot.

A determination is then made as to whether the operational condition of the emulated service satisfies the retrieved monitoring rule as evaluated (step 708). If not, then the process is complete.

It may be assumed that the process that is shown in FIG. 7A is only a portion of a larger process. For example, a set of monitoring rules from a monitoring rule database may be loaded during the initialization of the morphing honeypot. Thereafter, the monitoring rules are updated within the database, and the morphing honeypot may dynamically update its copy of the monitoring rules as necessary. For example, an administrative user may be allowed to dynamically add or delete monitoring rules through an appropriate interface.

In addition, the morphing honeypot may continually cycle through all of the monitoring rules, thereby performing the process that is shown in FIG. 7A for all of the monitoring rules. Moreover, rather than inserting and deleting monitoring rules from the database when the monitoring rules are active, the morphing honeypot may provide an interface for setting or resetting activation flags that are associated with the monitoring rules and that indicate whether a particular monitoring rule is active or inactive.

If the operational condition of the emulated service satisfies the retrieved monitoring rule at step 708, then an appropriate vulnerability alteration rule is retrieved (step 710). A vulnerability alteration rule directs the morphing activities of the morphing honeypot such that the morphing honeypot moves from presenting one personality to another personality. More specifically, a vulnerability alteration rule guides the selection of the next set of vulnerability information that should be presented by an emulated service. Whenever an operational condition of an emulated service is detected, as indicated by a monitoring rule, then the emulated service changes its personality in accordance with a vulnerability alteration rule.

Alternatively, rather than using a single vulnerability alteration rule, a plurality of vulnerability alteration rules may be associated with the previously retrieved monitoring rule; in other words, the previously retrieved monitoring rule also indicates a set of rules that should be used when the monitoring rule is satisfied. If a set of vulnerability alteration rules are indicated, then the set of vulnerability alteration rules may be evaluated in accordance with user-specified parameters and/or other information to select the vulnerability alteration rule that has a highest relevancy value, i.e. each vulnerability alteration rule may also have an expression that evaluates to indicate the appropriateness of choosing that particular vulnerability alteration rule.

In a manner similar to the monitoring rules, each vulnerability alteration rule may be configured as an expression with variables, and the user-specified parameters may be used as input into the expression prior to evaluating the expression. In this manner, there may be an expression to select a vulnerability alteration rule along with an expression that indicates the next vulnerability that should be used by the emulated service.

The user-specified parameters that are applicable to the selected vulnerability alteration rule are retrieved (step 712), and the next vulnerability is selected from the vulnerability database in accordance with the selected vulnerability alteration rule (step 714). The emulated service is then reconfigured in accordance with the new vulnerability (step 716), and the process is complete with respect to a particular monitoring rule.

With reference now to FIG. 7B, a flowchart depicts a more specific process for dynamically determining when to alter the information that indicates that a wireless morphing honeypot has vulnerable characteristics in accordance with monitored conditions. FIG. 7B is similar to FIG. 7A, although FIG. 7B differs from FIG. 7A in that FIG. 7A illustrates a process that is performed by a generalized morphing honeypot while FIG. 7B illustrates a more specific process of a wireless morphing honeypot in accordance with a different embodiment of the present invention.

The process begins by obtaining a monitoring rule for a wireless morphing honeypot in accordance with a previously implemented and active vulnerability, e.g., from a monitoring rule database or some other database associated with the wireless morphing honeypot (step 752). In other words, the wireless morphing honeypot is currently implementing a particular vulnerability by presenting a particular SSID, WEP key, MAC address, etc., to potential suspicious clients within the data transmissions of the wireless morphing honeypot. The retrieved monitoring rule may be applicable to one or more emulated wireless protocols or functions, but in a manner similar to FIG. 5B in which the 802.11® wireless communication protocol was used as an example, then the operational condition of the 802.11® emulated service, as indicated in the monitoring rule, is retrieved (step 754). The operational condition of the monitoring rule instructs the wireless morphing honeypot to continue employing the currently active vulnerability until a given set of criteria are satisfied with respect to detected operations. For example, the operational condition might instruct the wireless morphing honeypot to continue operations until suspicious events have been detected and reported, at which time the operation of the wireless morphing honeypot might be temporarily shutdown to prevent any further intrusion by a malicious user of the suspicious client, thereby allowing system administrators to physically investigate the location and identity of the suspicious client.

Any user-specified parameters that may be applicable to the retrieved monitoring rule are also retrieved (step 756), e.g., a schedule for varying the currently selected SSID or the currently selected WEP key. A determination is then made as to whether the operational condition of the emulated 802.11® service satisfies the retrieved monitoring rule as evaluated (step 758). If not, then the process is complete; in other words, the wireless morphing honeypot should continue to employ the currently active vulnerability because the current operational condition of the wireless morphing honeypot did not require any modification as specified by the monitoring rule. Again, it may be assumed that the process that is shown in FIG. 7B is only a portion of a larger process. For example, the wireless morphing honeypot may continually cycle through multiple monitoring rules, thereby performing the process that is shown in FIG. 7B for multiple monitoring rules that represent a series of scenarios that have been configured by a system administrative user.

If the operational condition of the emulated 802.11® service satisfies the retrieved monitoring rule at step 758, then an appropriate vulnerability alteration rule is retrieved (step 760). As mentioned previously, a vulnerability alteration rule directs the morphing activities of the wireless morphing honeypot such that the morphing honeypot moves from presenting one vulnerability or personality to another vulnerability or personality. With respect to the specific operations of a wireless morphing honeypot, the vulnerability alteration rule may indicate that the currently selected SSID, the currently selected WEP key, or the currently selected MAC address should be varied.

The user-specified parameters that are applicable to the selected vulnerability alteration rule are retrieved (step 762). For example, in the case of a wireless morphing honeypot, the SSID or WEP key generation algorithms may allow user-specified input parameters, thereby providing a system administrator with the ability to cycle through a set of known SSID's or a set of known WEP keys rather than employing randomly unique SSID's or WEP keys. The new vulnerability, is selected in accordance with the selected vulnerability alteration rule (step 764), e.g., as represented by a new SSID or WEP key that is computed in accordance with a SSID generation algorithm or a WEP key generation algorithm. The emulated service in the wireless morphing honeypot is then reconfigured in accordance with the new vulnerability (step 766), and the process is complete with respect to a particular monitoring rule.

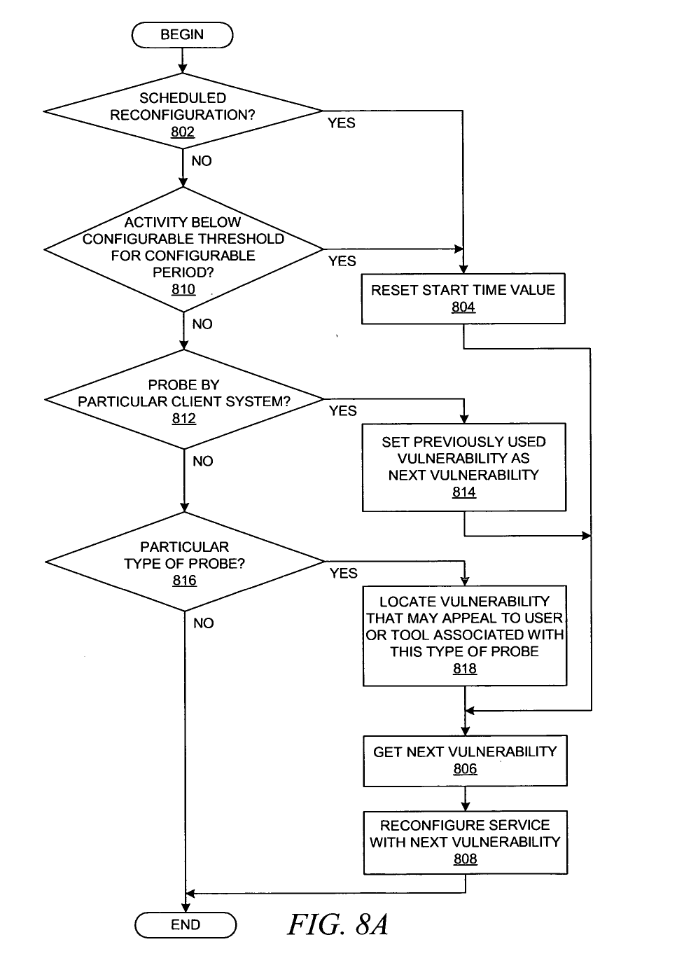

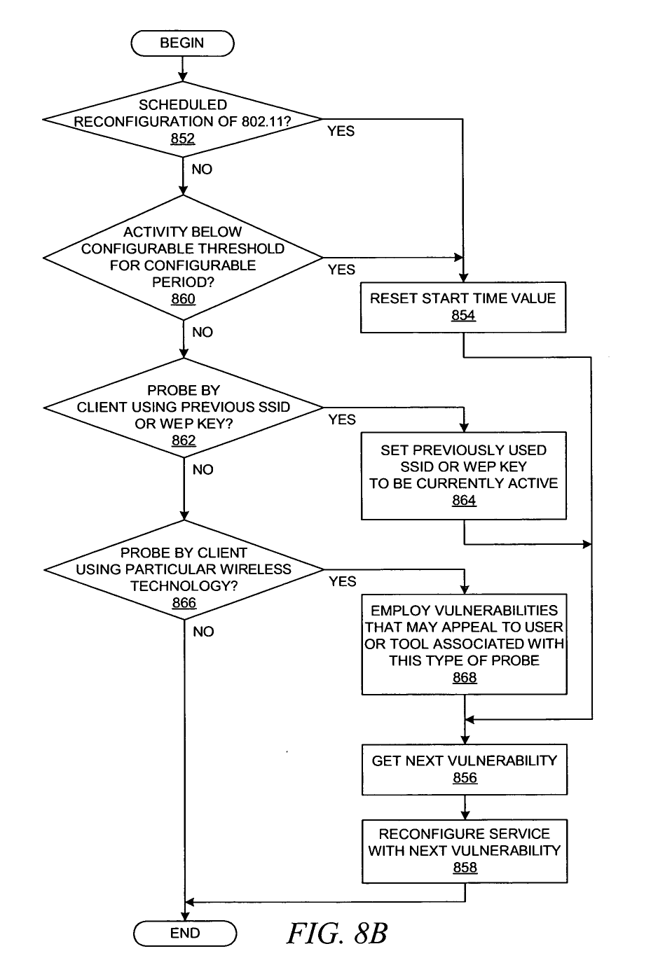

With reference now to FIG. 8A, a flowchart depicts some of the monitoring conditions that might be considered by a morphing honeypot. The process that is shown in FIG. 7A performs an evaluation of a monitoring rule followed by the evaluation of a vulnerability alteration rule. FIG. 8A is similar to FIG. 7A in that FIG. 8A provides examples of morphing conditions; the description of the processing of these conditions combines aspects of evaluating monitoring conditions along with aspects of selecting a new vulnerability to be presented by the morphing honeypot.

The process begins with a determination of whether or not a point in time has been reached when a scheduled reconfiguration should be triggered (step 802). For example, an administrative user may select many options within an administrative management utility for the morphing honeypot. Some of these options may provide the ability to select various temporal parameters for the morphing conditions; examples of temporal parameters may include: a repeatable cycle for changing the personality of the morphing honeypot; particular dates and times when the morphing honeypot will alter its behavior; a schedule of multiple dates and times for presenting new vulnerabilities; or some other time-related value. The condition may be triggered by the expiration of a previously created software timer. If a scheduling condition for a monitoring rule is matched, then an associated timer is reset if necessary (step 804), and a next vulnerability is obtained (step 806). The scheduling condition may have a vulnerability alteration rule that iterates through a set of selected or pre-determined vulnerabilities. The appropriate service is then reconfigured to present information reflecting a different vulnerability (step 808), and the process is complete.

If a scheduled reconfiguration has not been triggered at step 802, then a determination is made as to whether a condition has been triggered in which the morphing honeypot determines that logged activity by the morphing honeypot is below a previously configured threshold value for a previously configured amount of time (step 810). In this scenario, the amount of logged activity is relied upon by an administrative user as an indicator of the attractiveness of the morphing honeypot to malicious users. In addition, it is assumed that the morphing honeypot can experience more probes, more attempted attacks, or more actual attacks if the vulnerable characteristics of the honeypot are changed to match the vulnerabilities that are sought by a malicious user. The condition may be triggered by the expiration of a previously created software timer, at which time the morphing honeypot reviews the activities of all emulated services, a subset of emulated services, or a single emulated service. Various heuristics may be employed to determine whether or not the level of activity is insufficient, thereby triggering the reconfiguration operation; these heuristics may also be stored in the form of expressions, wherein activity-related parameters from one or more activity logs are used to evaluate the expression. If the condition is matched, then a timer value may be reset if necessary at step 804, and a next vulnerability is obtained at step 806. The appropriate service is then reconfigured to present information reflecting a different vulnerability at step 808, and the process is complete.

If an inactivity threshold is not violated at step 810, then a determination is made as to whether or not a probe has been detected from a particular client system (step 812). In this scenario, the morphing honeypot may track suspicious requests over time from a particular client system. For example, a client system may be identified by an IP address, and an emulated service can be configured to scan for the particular IP address. If a subsequent request is received from the previously identified IP address, then the emulated service can notify the monitoring engine within the morphing honeypot, which then determines whether a monitoring rule is triggered by the receipt of a request from the particular client system. After this particular monitoring rule is triggered, the morphing honeypot may attempt to present the same vulnerability that was previously presented to the client system in an effort to entice a malicious user into thinking that the emulated service has not changed its behavior since a previous probe. In the process shown in FIG. 8A, the morphing honeypot sets the next vulnerability to the vulnerability that was previously presented to this particular client system (step 814), which may have been stored within the activity log database when the previous probe was logged. Thereafter, the morphing honeypot gets the next vulnerability at step 806, and the appropriate service is then reconfigured to present information reflecting a different vulnerability at step 808, and the process is complete.

Alternatively, rather than attempting to present the same vulnerability that was previously presented to the client system, the morphing honeypot may present vulnerability information to the client system in an effort to entice a malicious user into thinking that the emulated service has specifically changed its behavior in response to a previous probe or attack.

For example, a malicious user might attempt to attack a typical production system from a particular client system based on a discovered vulnerability in the production system. In response, an administrative user might install a particular operating system patch that is known to fix the vulnerability. However, the newly installed operating system patch may have a different vulnerability that could be exploited by the malicious user, and the malicious user might expect to participate in a series of actions and counteractions in which a production system is updated in response to probes or attacks by the malicious user.

The morphing honeypot may be configured to play to the expectations of the malicious user; the morphing honeypot can lure the malicious user into thinking that a previously presented vulnerability was specifically fixed in response to activities by the malicious user. The morphing honeypot can be configured such that a series of vulnerability alteration rules can follow a particular chain of known vulnerabilities and fixes. In this manner, the morphing honeypot appears to the malicious user to be a constantly upgraded system, thereby luring the malicious user into activities at the morphing honeypot while concealing the true nature of the honeypot.

If a probe by a particular client system is not detected at step 814, then a determination is made as to whether or not a particular type of probe is detected (step 816). If not, the process is complete, after which the morphing honeypot may perform other duties, such as storing activity logs, and the process of evaluating monitoring rules would be started again at some later point in time. In addition, the morphing honeypot may be multithreaded such that various monitoring conditions are constantly evaluated through dedicated threads.

A particular type of probe may be detected at step 816 through the use of reverse fingerprinting, as mentioned above. By analyzing one or more requests or one or more data packets, the morphing honeypot may determine that a client system is probing for a particular form of vulnerability, particularly in a scenario in which the morphing honeypot is not implemented on a production system and should not be receiving any legitimate data traffic.

If a particular type of probe is detected, then the morphing honeypot searches for and locates a next vulnerability that may appeal to a malicious user or tool that is associated with the detected type of probe (step 818). Thereafter, the morphing honeypot gets the next vulnerability at step 806, and the appropriate service is then reconfigured to present information reflecting a different vulnerability at step 808, and the process is complete.

With reference now to FIG. 8B, a flowchart depicts some of the more specific monitoring conditions that might be considered by a wireless morphing honeypot. The process begins with a determination of whether or not a point in time has been reached when a scheduled reconfiguration should be triggered within an emulated wireless protocol service, such as 802.11® (step 852). For example, an administrative user may select many options within an administrative management utility for the wireless morphing honeypot, and the condition may be triggered by the expiration of a previously created software timer. If a scheduling condition for a monitoring rule is matched, then an associated timer is reset if necessary (step 854), and a next vulnerability is obtained (step 856). The scheduling condition may have a vulnerability alteration rule that iterates through a set of selected or pre-determined vulnerabilities. The appropriate service is then reconfigured to present information reflecting a different vulnerability (step 858), and the process is complete.

In a first alternative, user-specified parameters might represent a schedule to be employed by the wireless morphing honeypot for broadcasting the SSID, thereby controlling at what times the SSID is broadcast such that the wireless morphing honeypot can be controlled to perform this operation only during non-business hours of the enterprise that is employing the wireless morphing honeypot. In a second alternative, the user-specified parameters might represent a schedule for varying the SSID, thereby allowing the SSID to be varied weekly, daily, etc., or possibly in accordance with a recognition of a pattern for prior detected intrusion events by a suspicious client that is stored within a historical database.

In a third alternative, the user-specified parameters might represent a schedule for broadcasting a faux data transmission in which the content data is weakly encrypted with a WEP key that was previously selected. Additionally, the wireless morphing honeypot could be instructed to vary the encrypted content of the faux data transmission based on a schedule.

In a fourth alternative, the user-specified parameters might represent a schedule for varying the WEP key. For example, if no suspected probing events are detected for a long period of time, the WEP key may be changed, thereby presenting an appearance of heightened security to possible malicious users that are sniffing data transmissions. Additional or alternative operational conditions can be placed on the monitoring rules for the currently implemented vulnerability or vulnerabilities.

If a scheduled reconfiguration has not been triggered at step 852, then a determination is made as to whether a condition has been triggered in which the wireless morphing honeypot determines that logged activity by the wireless morphing honeypot is below a previously configured threshold value for a previously configured amount of time (step 860). If the condition is matched, then a timer value may be reset if necessary at step 854, and a next vulnerability is obtained at step 856. The appropriate service is then reconfigured to present information reflecting a different vulnerability at step 858, and the process is complete. In this manner, scheduled variations in the operation of the wireless morphing honeypot can be dynamically randomized in accordance with current observations or current patterns of inactivity of detected suspicious events.

If an inactivity threshold is not violated at step 860, then a determination is made as to whether or not a probe that employs a previously used SSID or WEP key has been detected (step 862). After this particular monitoring rule is triggered, the wireless morphing honeypot may attempt to present the same SSID or WEP key that was previously presented to the client system in an effort to entice a malicious user into thinking that the emulated service has not changed its behavior since the malicious user's previous activity. In the process shown in FIG. 8B, the morphing honeypot sets the next vulnerability to employ the previous SSID or WEP key that was previously presented to this particular client system and that the client is currently attempting to use (step 864), which may have been stored within an activity log database or a historical database by the wireless morphing honeypot. Thereafter, the wireless morphing honeypot gets the next vulnerability at step 856, and the appropriate service is then reconfigured to present information reflecting a different vulnerability at step 858, and the process is complete.

As mentioned above, the wireless morphing honeypot may broadcast faux data transmissions in which the content data is weakly encrypted with a WEP key that was previously selected or generated; the wireless morphing honeypot may operate in conjunction with a dummy client, e.g., similar to dummy client 580 that is shown in FIG. 5B, such that data transmissions are generated to and from the wireless morphing honeypot, thereby making the faux data transmission appear more realistic to a malicious user. Additionally, the wireless morphing honeypot could be instructed to vary the encrypted content of the faux data transmission based on a schedule.

In this manner, a malicious user may be lured into thinking that the wireless morphing honeypot is an active wireless access point that is engaged in real communications with an authorized wireless client. Under this impression, the malicious user may engage a passive client to perform a sniffing operation to record the wireless data transmissions. At some later point in time, the malicious user would attempt through various cryptographic key cracking algorithms to discover the WEP key that was used to encrypt the recorded data transmissions. Assuming that the faux data is weakly encrypted and that the malicious user is able to discover the WEP key, it may be assumed that the malicious user might use a client at some later point in time to communicate with the wireless morphing honeypot using the discovered WEP key. It may be assumed that the wireless morphing honeypot has the appropriate speed and computational resources to analyze unexpectedly received data transmissions for content that is encrypted with a WEP key that has been employed by the wireless morphing honeypot at some previous point in time, e.g., by attempting to decrypt the data transmissions with the previously used WEP keys. When the wireless morphing honeypot detects the use of a previously employed WEP key, the wireless morphing honeypot would report the suspicious event; in addition, this particular suspicious event would be an operational condition that triggers a monitoring rule, e.g., at step 758 as shown in FIG. 7B or at step 862 in FIG. 8B, to change the currently selected WEP key to the previously employed WEP key, e.g., through steps 760-766 in FIG. 7B or steps 864, 856, and 858 in FIG. 8B, so that the wireless morphing honeypot can engage the suspicious client in further data transmissions. Since the wireless morphing honeypot is able to implement multiple morphing emulated services, the wireless morphing honeypot may also provide apparent access to valuable databases throughout a simulated network or throughout a limited network that is deployed only for honeypot purposes. In this manner, the malicious user may be led to believe that he or she is able to operate the suspicious client to access databases or other resources, thereby keeping the malicious user engaged with the wireless morphing honeypot while the enterprise that is operating the wireless morphing honeypot employs other security resources or personnel to physically investigate the location and identity of the suspicious client and the nature of the attempted computational probing event.

If a probe that employs a previously used SSID or WEP key is not detected at step 862, then a determination is made as to whether or not a probe is detected by the wireless morphing honeypot in which the probe or suspicious activity employs a particular type of wireless technology or protocol in an unexpected manner (step 866). A particular type of probe may be detected at step 866 through the use of a radio signal analyzer that listens for broadcasts of sufficient strength at particular frequencies. By analyzing one or more data transmissions, the wireless morphing honeypot may determine that a client system is probing for a local wireless access point, particularly in a scenario in which the wireless morphing honeypot should not be receiving any legitimate data traffic. If a particular type of probe is detected, then the wireless morphing honeypot searches for and finds a next vulnerability that may appeal to a malicious user or tool that is associated with the detected type of probe (step 868). Thereafter, the wireless morphing honeypot selects the next vulnerability at step 856, and the appropriate wireless protocol service is then reconfigured to present information reflecting a different vulnerability at step 858, and the process is complete. If a probe is not detected at step 866 by the wireless morphing honeypot in which the probe or suspicious activity employs a particular type of wireless technology or protocol in an unexpected manner, the process is complete, after which the wireless morphing honeypot may perform other duties, such as storing activity logs, and the process of evaluating monitoring rules would be started again at some later point in time. In addition, the wireless morphing honeypot may be multithreaded such that various monitoring conditions are constantly evaluated through dedicated threads.

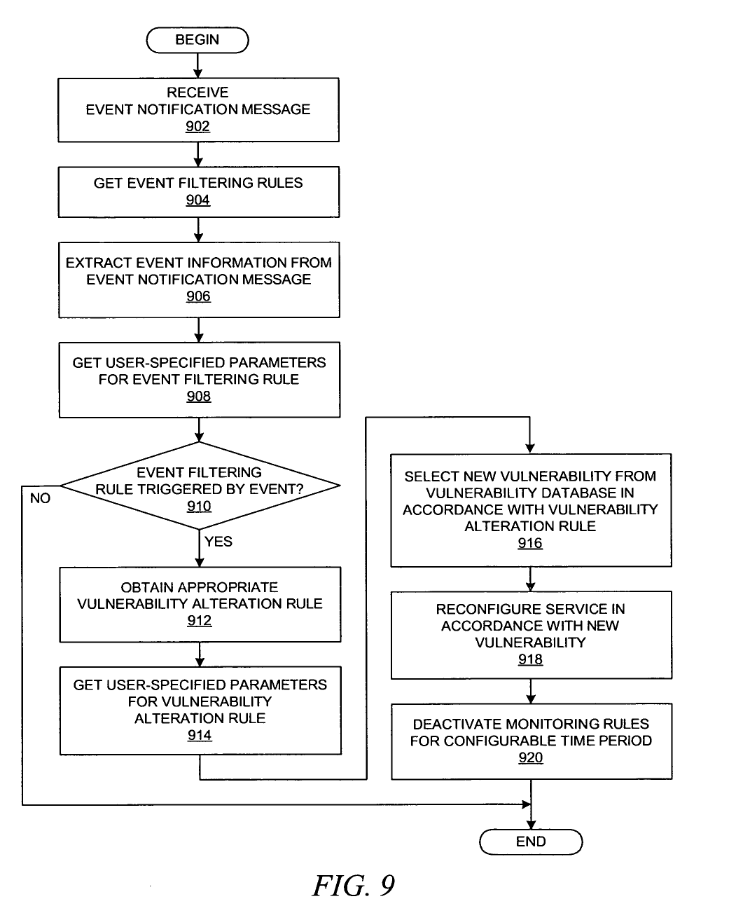

With reference now to FIG. 9, a flowchart depicts a process for dynamically determining when to alter the information that indicates that the honeypot has vulnerable characteristics in accordance with event notifications. The process begins when an event notification message is received (step 902), e.g., from an intrusion detection system. The morphing honeypot obtains a set of event filtering rules (step 904), e.g., from a morphing honeypot configuration database or some other database associated with the morphing honeypot. The event information is then extracted from the event notification message (step 906). As noted above, the event notification message may be received from a variety of sources for a variety of purposes; hence, the event information may include various types of information, e.g., an indication of a type of operating system and a type of service.

Any user-specified parameters that may be applicable to the retrieved event filtering rules are also retrieved (step 908). Each event filtering rule may be configured as an expression with variables, and the user-specified parameters may be used as input into the expression prior to evaluating the expression. In this manner, a set of event filtering rules may be stored like a template, and the user-specified parameters configure the event filtering rules for a particular honeypot as desired by an administrative user.

A determination is then made as to whether any of the retrieved event filtering rules are triggered by the event notification (step 910). If not, then the process is complete.

It may be assumed that the process that is shown in FIG. 9 is only a portion of a larger process. For example, a set of event filtering rules from an event filtering rule database may be loaded during the initialization of the morphing honeypot. Thereafter, the event filtering rules are updated within the database, and the morphing honeypot may dynamically update its copy of the event filtering rules as necessary. For example, an administrative user may be allowed to dynamically add or delete event filtering rules through an appropriate interface.

If the received event notification satisfies a retrieved event filtering rule at step 910, then an appropriate vulnerability alteration rule is retrieved (step 912). Whenever an event filtering rule is triggered by an event notification, as indicated by an event filtering rule, then the emulated service changes its personality in accordance with a vulnerability alteration rule. In a manner similar to that described above for monitoring rules, a plurality of vulnerability alteration rules may be associated with the previously retrieved event filtering rule.

Any user-specified parameters that are applicable to a selected vulnerability alteration rule are retrieved (step 914), and the next vulnerability is selected from the vulnerability database in accordance with the selected vulnerability alteration rule (step 916). The emulated service is then reconfigured in accordance with the new vulnerability (step 918).

Although it may be desirable to have the morphing honeypot change personalities in response to monitored conditions and events, it may also be desirable to prevent the personality of the morphing honeypot from changing too frequently. Since an event notification message is received from a system or an application that is external to the morphing honeypot, the morphing honeypot may be configured so that the event filtering rules take precedence over any active monitoring rules. In this example, any active monitoring rules are deactivated for a configurable time period after the personality of the morphing honeypot is changed in response to an event notification (step 920), and the process is complete.

With reference now to FIG. 10, a block diagram illustrates the manner in which a wireless morphing honeypot may be employed to physically locate and track suspicious client devices that may be attempting to probe the computation assets of an enterprise using known vulnerabilities in wireless protocols. In a manner similar to network 101 that is shown in FIG. 1A, corporate network 1002 supports legitimate wireless access points 1004 and 1006 that enable clients 1008-1018 to communicate with each other and with servers, databases, and other data processing system components that are not illustrated. Wireless morphing honeypots 1020 and 1022 are deployed to protect corporate assets from unwanted eavesdropping, i.e. data transmission sniffing or monitoring, or more importantly, to protect corporate computational asserts from unwanted intrusions and malicious activity. In addition to presenting wireless vulnerabilities, wireless morphing honeypot 1020 may also present dynamically configurable emulated services and/or associated vulnerabilities, which may differ from those that are presented by wireless morphing honeypot 1022.

Wireless morphing honeypots 1020 and 1022 may be specifically spatially located with respect to valid wireless access points 1004 and 1006 as a wireless deterrent perimeter, e.g., around the boundary of a corporate building or campus, that acts to attract malicious users to interacting with wireless morphing honeypots 1020 and 1022 rather than with valid wireless access points 1004 and 1006 based on the attractiveness of the stronger radio signals that are presented by wireless morphing honeypots 1020 and 1022. In a computing environment that is employing 802.11® wireless technologies, clients 1008-1018 are configured to operate with legitimate wireless access points 1004 and 1006, e.g., by using valid SSID's and WEP keys within an 802.11® protocol; hence, clients 1008-1018 will ignore the availability of wireless morphing honeypots 1020 and 1022.

In a manner similar to that described above, wireless morphing honeypots 1020 and/or 1022 detect improper activity from suspicious client 1024, and the improper activity is reported to intrusion detection system 1026. Suspicious client 1024 may attempt to interact with legitimate wireless access points 1004 and 1006 rather than wireless morphing honeypots 1020 and 1022; it may be assumed, though, that legitimate wireless access points 1004 and 1006 have been configured with strong security to deter malicious activities, at least with respect to exploiting vulnerabilities in the deployed wireless protocols.

Based on the reported improper activity, intrusion detection system 1026 employs its triangulation, i.e. location detection, unit 1028 in an attempt to determine the spatial location of suspicious client 1024. For example, if only wireless morphing honeypot 1020 reports suspicious activity, then it may be determined that the suspicious client is somewhere in the vicinity of wireless morphing honeypot 1020. However, if multiple reports of suspicious activity are received from multiple wireless morphing honeypots, then based on the sequence of reported suspicious activity, triangulation unit 1028 may be able to determine a movement vector for suspicious client 1024 with respect to the multiple wireless morphing honeypots.

Intrusion detection system 1026 sends, via its physical security system interface 1030, the approximate location data and/or approximate movement vector data to physical security system 1032, which is able to employ the location data and/or movement vector data to direct its physical security assets in order to attempt to obtain information about suspicious client 1024. In the example that is shown in FIG. 10, physical security system 1032 positions security cameras 1034-1038 in order to attempt to capture video data of a malicious user and/or suspicious client 1024. If the malicious user is operating suspicious client 1024 from a moving vehicle, e.g., in an activity that has been termed “war-driving” in which a person attempts to locate insecure wireless access points while in a moving vehicle with a specialized client that sniffs for data transmissions on certain radio frequencies that are used by certain wireless protocols and wireless technologies, physical security system 1032 may be able to capture identifying information about the suspicious vehicle. Alternatively, physical security system 1032 could alert security personnel in the vicinity of suspicious client 1024 to the suspicious activity, thereby physically thwarting the suspicious activity.

As noted above, clients 1008-1018 are configured to operate with legitimate wireless access points 1004 and 1006, thereby ignoring wireless morphing honeypots 1020 and 1022. However, depending upon the vulnerabilities that are configured to be presented by wireless morphing honeypots 1020 and 1022, it is possible that clients 1008-1018 may attempt to communicate with wireless morphing honeypots 1020 and 1022 rather than legitimate wireless access points 1004 and 1006, particularly depending upon the location of a user of one of clients 1008-1018 in relation to wireless morphing honeypots 1020 and 1022.

The advantages of the present invention should be apparent in view of the detailed description that is provided above. The wireless morphing honeypot of the present invention increases the likelihood that a malicious user will identify the honeypot as a vulnerable system that seems ripe for nefarious wireless interaction. The wireless morphing honeypot can change its characteristics to entice a malicious user to something that the malicious user might consider as more vulnerable, exploitable, and, therefore, more intriguing. The overall security of a distributed data processing system or network is increased if a computer administrator is able to keep a malicious user interested in the wireless honeypot system while providing time to determine the identity and location of the malicious user. Moreover, if an outright use of the wireless morphing honeypot is accomplished by a malicious user, an administrator may be able keep the attack shunted to particular systems within an enterprise, thereby limiting any damage that might be caused or any information that might be compromised. By integrating the actions of the wireless morphing honeypot with the events that are detected by an intrusion detection system, a computer administrator is provided with a tool for performing limited physical security operations.

It is important to note that while the present invention has been described in the context of a fully functioning data processing system, those of ordinary skill in the art will appreciate that some of the processes associated with the present invention are capable of being distributed in the form of instructions in a computer readable medium and a variety of other forms, regardless of the particular type of signal bearing media actually used to carry out the distribution. Examples of computer readable media include media such as EPROM, ROM, tape, paper, floppy disc, hard disk drive, RAM, and CD-ROMs and transmission-type media, such as digital and analog communications links.

The description of the present invention has been presented for purposes of illustration but is not intended to be exhaustive or limited to the disclosed embodiments. Many modifications and variations will be apparent to those of ordinary skill in the art. The embodiments were chosen to explain the principles of the invention and its practical applications and to enable others of ordinary skill in the art to understand the invention in order to implement various embodiments with various modifications as might be suited to other contemplated uses.

1. A method for operating a data processing system, the method comprising:
configuring a wireless access point device within the data processing system to use a wireless protocol in accordance with user-specified values for configurable parameters in the wireless protocol;
obtaining a configurable rule for altering one or more values for one or more configurable parameters in the wireless protocol in response to a detected operational condition of the wireless access point device; and
automatically altering a value for a configurable parameter in the wireless protocol in accordance with a configurable rule and a detected operational condition of the wireless access point device.

2. The method of claim 1 further comprising:
generating an alert message in response to a detected operational condition of the wireless access point device.

3. The method of claim 1 further comprising:
detecting, as an operational condition of the wireless access point device, a receipt of a wireless communication during a time period in which the wireless access point device is configured to generate an alert for a received wireless communication.

4. The method of claim 1 further comprising:
extracting an SSID (Secondary Set ID) from a received wireless communication; and
detecting, as an operational condition of the wireless access point device, that the extracted SSID matches an SSID that is stored in a historical database of SSID's.

5. The method of claim 1 further comprising:
extracting an SSID (Secondary Set ID) from a received wireless communication; and
detecting, as an operational condition of the wireless access point device, that the extracted SSID matches an SSID that is currently being used by the wireless access point device for faux wireless communications.

6. The method of claim 1 further comprising:
extracting encrypted content data from a received wireless communication;
analyzing the received wireless communication by attempting to decrypt the encrypted content data using a cryptographic key from a historical database of cryptographic keys; and
detecting, as an operational condition of the wireless access point device, that the cryptographic key decrypts the encrypted content data.

7. The method of claim 1 further comprising:
extracting encrypted content data from a received wireless communication;
analyzing the received wireless communication by attempting to decrypt the encrypted content data using a cryptographic key that is currently being used by the wireless access point device for faux wireless communications; and
detecting, as an operational condition of the wireless access point device, that the cryptographic key decrypts the encrypted content data.

8. The method of claim 1 further comprising:
receiving a wireless communication at the wireless access point device;
detecting an operational condition of the wireless access point device that indicates that the wireless communication represents suspicious activity by a client; and
determining an approximate location of the client based on information about the wireless communication and based on locations of one or more wireless access point devices.

9. The method of claim 8 further comprising:
notifying a physical security system with data for the approximate location of the client.

10. The method of claim 9 further comprising:
attempting to obtain video data of the client by the physical security system.

11. The method of claim 1 further comprising:
emulating a service on a server or the wireless access point device;
in response to receiving a request at the emulated service, sending a response that comprises information indicating a set of vulnerable characteristics at the server; and
automatically altering the set of vulnerable characteristics.

12. The method of claim 11 further comprising:
configuring a database of vulnerable characteristics;
selecting the set of vulnerable characteristics from the database of vulnerable characteristics in accordance with a type of operating system, a type of emulatable service, or a type of vulnerable characteristic.

13. The method of claim 11 further comprising:
logging activity by the emulated service; and
deriving the set of vulnerable characteristics from the database of vulnerable characteristics in accordance with logged activity by the emulated service.

14. The method of claim 13 further comprising:
triggering an automatic alteration of the set of vulnerable characteristics in response to logged activity by the emulated service being below a configurable threshold value.

15. An apparatus for processing wireless communications within a data processing system, the apparatus comprising:
means for configuring a wireless access point device within the data processing system to use a wireless protocol in accordance with user-specified values for configurable parameters in the wireless protocol;
means for obtaining a configurable rule for altering one or more values for one or more configurable parameters in the wireless protocol in response to a detected operational condition of the wireless access point device; and
means for automatically altering a value for a configurable parameter in the wireless protocol in accordance with a configurable rule and a detected operational condition of the wireless access point device.

16. The apparatus of claim 15 further comprising:
means for extracting encrypted content data from a received wireless communication;
means for analyzing the received wireless communication by attempting to decrypt the encrypted content data using a cryptographic key from a historical database of cryptographic keys; and
means for detecting, as an operational condition of the wireless access point device, that the cryptographic key decrypts the encrypted content data.

17. The apparatus of claim 15 further comprising:
means for extracting encrypted content data from a received wireless communication;
means for analyzing the received wireless communication by attempting to decrypt the encrypted content data using a cryptographic key that is currently being used by the wireless access point device for faux wireless communications; and
means for detecting, as an operational condition of the wireless access point device, that the cryptographic key decrypts the encrypted content data.

18. A computer program product on a computer-readable medium for use in a data processing system for processing wireless communications, the computer program product comprising:
means for configuring a wireless access point device within the data processing system to use a wireless protocol in accordance with user-specified values for configurable parameters in the wireless protocol;
means for obtaining a configurable rule for altering one or more values for one or more configurable parameters in the wireless protocol in response to a detected operational condition of the wireless access point device; and
means for automatically altering a value for a configurable parameter in the wireless protocol in accordance with a configurable rule and a detected operational condition of the wireless access point device.

19. The computer program product of claim 18 further comprising:
means for extracting encrypted content data from a received wireless communication;
means for analyzing the received wireless communication by attempting to decrypt the encrypted content data using a cryptographic key from a historical database of cryptographic keys; and
means for detecting, as an operational condition of the wireless access point device, that the cryptographic key decrypts the encrypted content data.

20. The computer program product of claim 18 further comprising:
means for extracting encrypted content data from a received wireless communication;
means for analyzing the received wireless communication by attempting to decrypt the encrypted content data using a cryptographic key that is currently being used by the wireless access point device for faux wireless communications; and
means for detecting, as an operational condition of the wireless access point device, that the cryptographic key decrypts the encrypted content data.
